(19) United States
(12) Patent Application Publication
(10) Pub. No.: US 2023/0172096 A1
(43) Pub. Date: Jun. 8, 2023

(54) APPARATUS, SYSTEM, AND METHOD FOR CALIBRATION OF LIQUID FERTILIZER DISTRIBUTION

(71) Applicant: Kinze Manufacturing, Inc., Williamsburg, IA (US)

(72) Inventors: Steve Nolte, Williamsburg, IA (US); Philip Willis, Williamsburg, IA (US); Denny Williams, Williamsburg, IA (US); Austin Flugum, Williamsburg, IA (US)

(21) Appl. No.: 18/052,715

(22) Filed: Nov. 4, 2022

Related U.S. Application Data
(60) Provisional application No. 63/263,608, filed on Nov. 5, 2021.

(51) Int. Cl. A01C 21/00; B05B 12/08; B05B 12/12; A01C 23/00; A01B 49/06

(52) U.S. Cl. CPC A01C 21/002; B05B 12/085; B05B 12/081; B05B 12/12; A01C 23/007; A01B 49/06; A01C 23/008

(57) ABSTRACT

An agricultural implement includes the calibration of liquid fertilizer distribution for an agricultural implement. The calibration system measures the level of the liquid fertilizer or utilizes a known volume in a container and the pressure of the liquid fertilizer. The system uses the level and pressure to calculate the density of the liquid fertilizer, which helps achieve more consistent fertilizer application. Additionally, the density of the liquid fertilizer can be used to more accurately measure the tank level of a particular tank. The system can include a tilt sensor and valves so that when the agricultural implement is traversing a hill or otherwise rough terrain, the system can accurately measure tank level and selectively draw liquid fertilizer from a particular tank or tanks to mitigate spillage. The system also can measure and monitor the tank level of the tank or tanks and automatically fill the tank or tanks based on the measured tank level.

### CROSS REFERENCE TO RELATED APPLICATIONS

This application claims priority under 35 U.S.C. § 119 to provisional patent application U.S. Ser. No. 63/263,608, filed Nov. 5, 2021. The provisional patent application is herein incorporated by reference in its entirety, including without limitation, the specification, claims, and abstract, as well as any figures, tables, appendices, or drawings thereof.

### FIELD OF THE INVENTION

The invention relates generally to an apparatus, system, and/or corresponding method of use in at least the delivering of liquid products, for a liquid application system, generally applicable to fertilizers, and calibration thereof. More particularly, but not exclusively, the invention relates to an apparatus, system, and/or method for calibration of liquid fertilizer distribution.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Agricultural fertilizer systems generally include the application of dry or liquid fertilizers. For those that do not use a liquid, they use granular or other forms of fertilizer that are difficult to handle and apply, difficult to blend and to apply uniformly. Because of this, other prior art has transitioned to liquid fertilizers. Consistent application of liquid fertilizer can prove problematic depending on the density of the fertilizer being used. Differing densities of liquid fertilizer can cause differing results in terms of application, which leads to inconsistencies in application. The densities can vary based upon a number of factors, including, but not limited to, ambient environment, combination of inputs, accuracy of desired combination, as well as others. The same fertilizer distribution system may perform poorly when a different fertilizer having a different density is used, as differing densities may cause problems when measuring the fullness of a tank/hopper containing liquid fertilizer material. Also, even in situations when the same fertilizer is used, weather conditions, such as ambient air pressure, can cause fluctuations in the density of the liquid fertilizer.

Inconsistent or undesirable application of liquid fertilizer can be problematic from both an agricultural/financial perspective and/or a safety/environmental perspective. For example, if less liquid fertilizer than is desirable is applied to an agricultural field, the crops in the field may suffer due to lack of nutrients based on lack of exposure to the proper amount of fertilizer. Thereby, a farmer's potential yield could suffer, which has a negative impact on the farmer's financial outlook. Also, spillage of fertilizer material results in financial loss for a farmer as the farmer is then forced to spend more money on additional fertilizer material to replace the spilled fertilizer material. Over-application results in a farmer spending more money since more fertilizer material than is necessary is applied to an agricultural field. Additionally, from a safety/environmental perspective, applying more liquid fertilizer than is desirable can result in increased amounts of chemical runoff from the agricultural field. Humans and other animals in the surrounding area could potentially be negatively affected by being exposed to caustic or hazardous chemical runoff, and the surrounding environment could also be negatively affected due to increased chemical runoff.

Consistent application of liquid fertilizer can also prove problematic in situations wherein an agricultural field may contain hills or slightly sloped or rough terrain. Sloped areas in an agricultural field can cause agricultural equipment and/or fertilizer distribution equipment to tilt or otherwise be oriented in a non-horizontal manner with respect to the horizon. The tilted orientation may cause problems in the distribution of the liquid fertilizer, such as when there are multiple tanks, and one tank may be on the low end. When fertilizer distribution equipment encounters sloped or rough areas in an agricultural field, the tilting of the equipment may cause a tank containing liquid fertilizer to spill. When spillage occurs in an agricultural field, over-application may occur and/or human operators may be exposed to the fertilizer material which is often caustic or hazardous to humans. Spillage is also harmful to the environment at large, as it may result in unwanted chemical runoff. In addition, spillage is wasteful from a financial standpoint as it may result in a farmer needing to spend more money on additional fertilizer material to replace the spilled material.

Manually filling fertilizer distribution systems with liquid fertilizer can be dangerous because a human user is potentially exposed to hazardous fertilizer material. Manually filling fertilizer distribution systems also is time consuming and can result in unwanted spillage or underfilling/overfilling due to human error. Again, wasteful spillage can result in unsafe conditions for humans and other animals in the area, as well as having a negative environmental impact on the surrounding area. Additionally, spillage results in a farmer losing fertilizer material and, thus, wasting money. While there are examples in the art of automatically adjusting the rate or timing at which fertilizer is applied to an agricultural field, the prior art does not to include the ability to autofill a tank/hopper with liquid fertilizer based on current tank level wherein the system itself continuously monitors the tank level. Without a system in which a fertilizer distribution system can automatically fill its hoppers/tanks based on a tank level monitored by the system itself, farmers may lose time by needing to manually check the level of fertilizer in a tank before filling the tank.

Thus, there exists a need in the art for an apparatus, methods, and/or systems which provides proper calibration of fertilizer distribution in which the density of the fertilizer being used can be accurately measured. There is a need in the art for a calibration system that can accurately measure, in real time, the density of fertilizer being used to account for density fluctuations of any kind. There is a further need in the art to measure the density of liquid fertilizer being held in a tank/hopper in order to accurately measure the fullness of said tank/hopper.

There also exists a need in the art for an apparatus, methods, and/or systems which provides proper calibration of fertilizer distribution systems in which the distribution system can maintain consistent fertilizer application regardless of tilting or alteration that occurs to the distribution system due to field conditions or characteristics. There is also a need in the art for the ability to selectively pull fertilizer material from a particular tank or tanks to avoid or mitigate spillage when traversing sloped or otherwise rough terrain. There is also a need in the art for protecting crops, humans, and the environment from harmful effects due to inconsistent or over-application of fertilizer material or spillage.

There also exists a need in the art for liquid fertilizer distribution systems to be automatically filled based on continuous monitoring of the tank level in order to improve efficiency, safety, and cost effectiveness.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage to improve on or overcome the deficiencies in the art.

It is a further object, feature, and/or advantage to provide a system and associated method for the calibration of liquid fertilizer distribution and/or a liquid fertilizer distribution system.

It is still yet a further object, feature, and/or advantage to provide consistent application/distribution of liquid fertilizer to an agricultural field by measuring a liquid level of the liquid fertilizer, measuring a pressure of the liquid fertilizer, calculating a density of the liquid fertilizer based on the liquid volume, whether measured or known, such as by determining the liquid level and pressure, and further monitoring the density of the liquid fertilizer. Differences and/or changes in density of liquid fertilizer can cause inconsistent application/distribution of the liquid fertilizer on agricultural fields. By calculating and monitoring the density of the liquid fertilizer, the liquid fertilizer can be applied/distributed with more consistency.

It is yet a further object, feature, and/or advantage to accurately measure the fullness of a tank containing liquid fertilizer, wherein the measurement of fullness of the tank is based, at least in part, on the density of the liquid fertilizer contained in the tank. The measurement of a tank's fullness can also be referred to as the tank level of said tank.

It is another object, feature, and/or advantage to measure the tilt or orientation of the agricultural implement to recognize and determine when the implement is tilted relative to the horizon due to circumstances such as that the implement is traversing a hill, an incline or decline, and/or rough or otherwise uneven terrain. Moreover, it is important to be able to accurately measure the height of the liquid fertilizer when the agricultural implement or distribution system is tilted or otherwise altered so that density can be properly calculated, which results in more consistent application of the liquid fertilizer.

It is still yet a further object, feature, and/or advantage to selectively draw liquid fertilizer from a particular tank or tanks to avoid spillage. In instances when the agricultural implement, or portions thereof, is tilted or otherwise not level with respect to the horizon, the system may select to draw liquid fertilizer from a tank that is fuller than another tank to avoid the fuller tank from inadvertently spilling liquid fertilizer.

It is still yet a further object, feature, and/or advantage to include a liquid level sensor to measure the level of liquid fertilizer, a pressure sensor to measure the pressure of the liquid fertilizer, and/or a tilt sensor to measure the tilt of the agricultural implement and/or distribution system and to account for that tilt when measuring the level and pressure of the liquid fertilizer.

It is still yet a further object, feature, and/or advantage to provide the capability of automatically filling, or autofilling, the tanks of the distribution system with liquid fertilizer based, at least in part, on the measured liquid level of the liquid fertilizer and the liquid fertilizer's density, which corresponds to the fullness of the tank. The fullness of the tank can be referred to as the tank level.

The systems and/or methods disclosed herein can be used in a wide variety of applications. For example, the system can be used on a variety of agricultural implements to calibrate a liquid fertilizer distribution system in order to provide consistent application/distribution of liquid fertilizer on the plant products of an agricultural field. The calibration system disclosed can be used to calibrate the distribution of fertilizers, pesticides, herbicides, fungicides, and the like which are in liquid form.

It is preferred the system be safe, cost effective, and durable. For example, some of the advantages of the system include avoiding or mitigating fertilizer spillage so as to improve safety and cost effectiveness. Another advantage of the system is the capability to autofill rather than manually fill the liquid fertilizer so as to improve efficiency and safety. Another advantage of the system is to avoid inconsistent and/or over-or-under-application of liquid fertilizer to improve safety, efficiency, and cost effectiveness.

Methods can be practiced which facilitate use, manufacture, assembly, maintenance, and repair of a system which accomplish some or all of the previously stated objectives.

The system can be incorporated into larger designs which accomplish some or all of the previously stated objectives.

According to some aspects of the present disclosure, a system for calibrating liquid fertilizer distribution for an agricultural implement comprises a tank wherein liquid fertilizer is stored, a liquid level sensor to measure the level of the liquid fertilizer stored in the tank, and/or a pressure sensor used to measure the pressure of the liquid fertilizer stored in the tank.

According to at least some aspects of some embodiments disclosed, the system further comprises a drain and a valve wherein the liquid fertilizer may be released out of the tank through the drain and be applied to an agricultural field, and the valve is positioned between the tank and the drain wherein the valve may be open or closed, thereby dictating whether the liquid fertilizer is released from the tank.

According to at least some aspects of some embodiments disclosed, the system further comprises a tilt sensor to measure the tilt of the agricultural implement and/or the system, and account for any tilt when the level and/or pressure of the liquid fertilizer is being measured.

According to at least some aspects of some embodiments disclosed, the tilt sensor is able to recognize when the agricultural implement is traversing a hill or otherwise rough terrain by measuring the tilt of the agricultural implement and/or the system.

According to at least some aspects of some embodiments disclosed, the system further comprises a plurality of tanks with one or more valves positioned between the plurality of tanks, in which the system can use the one or more valves to selectively draw liquid fertilizer from a particular tank or tanks to mitigate spillage.

According to at least some aspects of some embodiments disclosed, the system further comprises an accelerometer to measure the speed and acceleration of the agricultural implement.

According to at least some aspects of some embodiments disclosed, based on a measured tank level, the system can autofill the tank with additional liquid fertilizer.

According to at least some aspects of some embodiments disclosed, the system further comprises an implement control system comprising zero or more IPRs, zero or more IPNs, zero or more IPPs, and zero or more displays, wherein the implement control system can sense, measure, monitor, and/or control aspects of the system.

According to at least some aspects of some embodiments disclosed, a system for calibrating liquid fertilizer distribution for an agricultural implement comprises one or more tanks wherein liquid fertilizer is stored, one or more liquid level sensors to measure the level of the liquid fertilizer stored in the one or more tanks, and one or more pressure sensors used to measure the pressure of the liquid fertilizer stored in the one or more tanks.

According to at least some aspects of some embodiments disclosed, a method for calibrating liquid fertilizer distribution for an agricultural implement comprises measuring the level of liquid fertilizer stored on or near the agricultural implement, measuring the pressure of the liquid fertilizer stored on or near the agricultural implement, and calculating the density of the liquid fertilizer based on the volume and pressure of the liquid fertilizer, wherein the volume is determined by a measured amount or by utilizing a known or fixed volume container for receiving the liquid fertilizer.

According to at least some aspects of some embodiments disclosed, the method further comprises opening or closing a valve to drain the liquid fertilizer from the agricultural component and apply the liquid fertilizer to an agricultural field or draw back the liquid fertilizer to a storage tank.

According to at least some aspects of some embodiments disclosed, the method further comprises measuring the tilt of the agricultural implement and accounting for the tilt of the agricultural implement when measuring the level and/or pressure of the liquid fertilizer.

According to at least some aspects of some embodiments disclosed, the step of measuring the tilt of the agricultural implement includes recognizing when the agricultural implement is traversing a hill or otherwise rough terrain.

According to at least some aspects of some embodiments disclosed, the method further comprises storing the liquid fertilizer in one or more tanks.

According to at least some aspects of some embodiments disclosed, the method further comprises selectively drawing liquid fertilizer from a particular tank or tanks, via one or more valves, to mitigate spillage.

According to at least some aspects of some embodiments disclosed, the method further comprises measuring speed and/or acceleration of the agricultural implement.

According to at least some aspects of some embodiments disclosed, the method further comprises measuring a tank level of the one or more tanks and automatically filling the agricultural implement with additional liquid fertilizer, based on the measured tank level.

According to at least some aspects of some embodiments disclosed, the method further comprises including an implement control system comprising zero or more IPRs, zero or more IPNs, zero or more IPPs, zero or more displays, wherein the implement control system can sense, measure, monitor, and/or perform aspects of the method.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a perspective view of an exemplary agricultural planting implement.

FIG. 2 is a front elevation view of the agricultural planting implement.

FIG. 3 is a side elevation view of the agricultural planting implement.

FIG. 4 is a perspective view of an exemplary agricultural vehicle.

FIG. 5 is a perspective view of an exemplary row unit for use with an agricultural planting implement.

FIG. 6 is a side elevation view of the row unit.

FIG. 7 is a schematic drawing of components of the calibration system according to one embodiment.

FIG. 8 is a block diagram of components of the calibration system according to one embodiment.

FIG. 9 is a perspective view of components of the calibration system according to one embodiment.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described and/or envisioned based upon that disclosed in the present specification and the figures.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

The term “particulate material” shall be construed to have a broad meaning, and includes, but is not limited to, grain, seed, fertilizer, insecticide, dust, pollen, rock, gravel, dirt, stock, or some combination thereof. Particulate material can be mixed with air to form airborne matter.

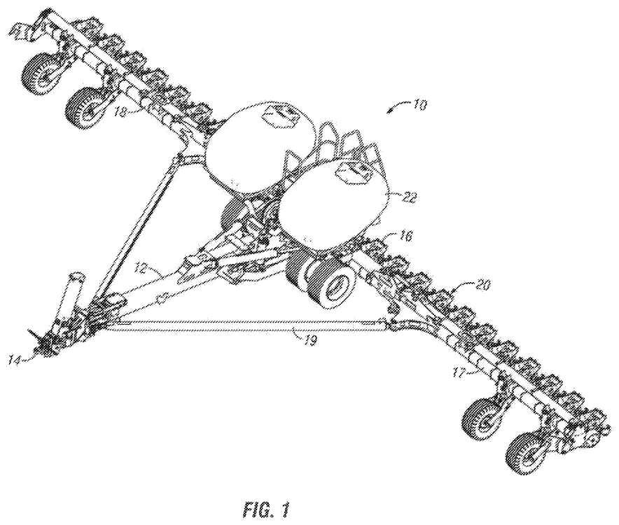

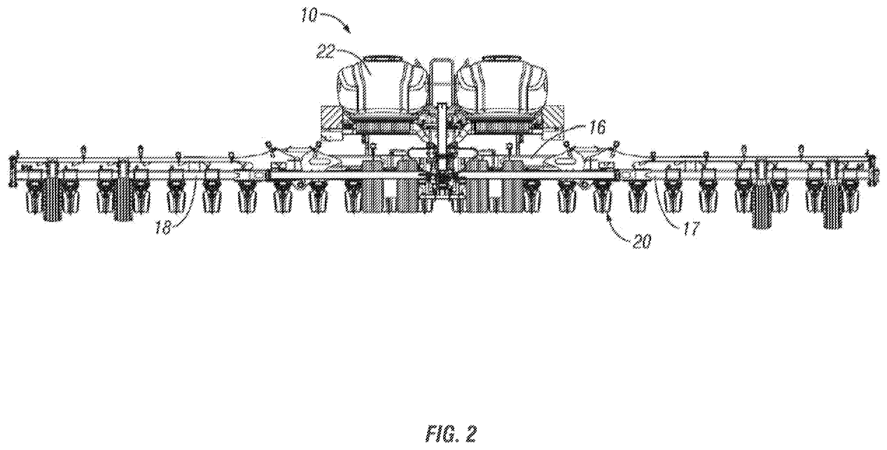

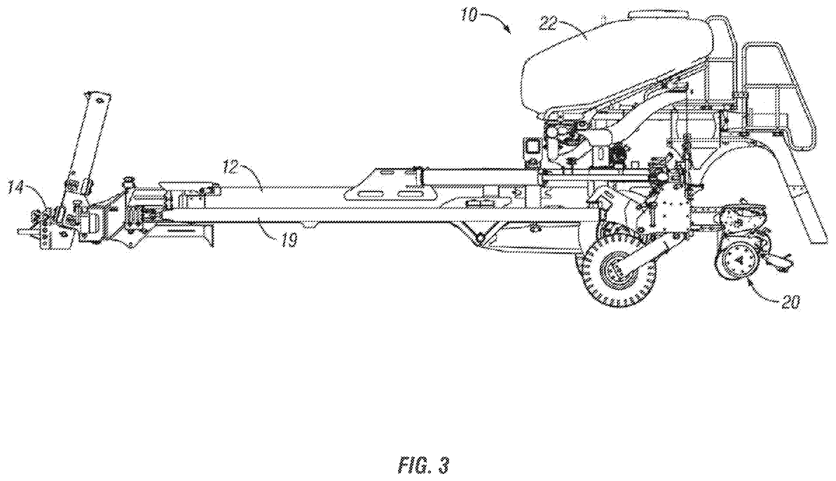

FIGS. 1-3 disclose an exemplary agricultural implement 10. The agricultural implement 10 as shown in the figures is a planting implement 10. Although the implement shown in FIGS. 1-3 is a planting implement, the calibration system, apparatus, and/or methods disclosed herein may be used with agricultural implements other than planting implements, such as but not limited to, seeders, sprayers, fertilizer spreaders, tillage equipment, plows, discs, and other implements. Additionally, the calibration system, apparatus, and/or methods disclosed may be used with a self-propelled agricultural implement, such as that disclosed in U.S. Pat. No. 10,104,824, which is hereby incorporated by reference in its entirety. The implement 10 may be generally any implement for engaging with the ground or otherwise distributing a material, such as a particulate or liquid material to the ground. As will be understood, the implement includes ways to distribute material, such as a particulate material to various ground engaging apparatus to evenly distribute said particulate material accurately, efficiently, and in some embodiments at high speed distribute said particulate material to or in said ground. Furthermore, as will be understood, while the planting implement 10 as shown in the figures is provided, additional types of implements including additional planting implements with various features as is known can utilize the invention and/or aspects thereof to be able to calibrate distribution of the particulate material such as seed, or a liquid material such as liquid fertilizer, to the ground.

The planting implement 10 as shown in the figures includes a tongue 12 with a hitch 14 at a first end and a tool bar 16 extending generally transversely to the tongue 12 at a second end. The tool bar 16 extends to connect to a plurality of row units 20, which include ground engagement apparatus. The row units 20 may also include additional aspects, such as metering elements, singulation elements, ground opening and/or closing elements, metering system, sensors, and the like. However, it is to be appreciated that generally other types of row units, ground engaging elements, and/or metering elements can utilize any of the aspects of the invention disclosed herein. For example, the row units 20 could include fertilizer or other particulate and/or liquid material application apparatus, and the entrainment system disclosed be used to distribute the particulate and/or liquid material to the row units 20.

Extending outwardly from the toolbar 16 and being generally an extension thereof are wing elements 17 and 18. The wing elements 17, 18 provide additional width of the toolbar such that additional row units 20 can be attached along thereto. This allows for a greater number of row units 20 to be attached to the toolbar to be used for distributing a particulate material and/or liquid fertilizer. Additional elements shown in the figures include draft links 19, which generally connect the wings 17, 18 to the tongue 12. One or more actuators can be connected to the system to provide for the wings 17, 18 to be folded in a generally forward manner wherein they will be somewhat parallel to the tongue 12 to move the planting implement 10 from a field use configuration to a row use configuration. However, additional planting units may include that the toolbar is lifted and rotated, is folded rearwardly, is folded vertically, does not fold at all, or includes some sort of combination thereof.

Agricultural planting implements, such as the one shown in FIGS. 1-3, are used to distribute, meter, and place particulate materials, such as seed, in operable and/or desired locations in a field. This is based, in part, on agronomical data, which is used to determine the optimal spacing, depth, and location of seed to give the seed the best chance to mature into a crop with the best possible yield. The exemplary agricultural implement 10 of FIGS. 1-3 includes central hoppers 22, wherein the central hoppers 22 may store particulate materials, such as seed, and/or liquid materials, such as liquid fertilizer, to be applied to an agricultural field. The exemplary agricultural implement 10 of FIGS. 1-3 may also apply liquid material, such as liquid fertilizer, to an agricultural field.

To further aid in increasing the performance and growing of crop from a planted seed, implements can include systems and other apparatus that are used to apply, place, or otherwise dispense a fertilizer, such as a liquid or dry fertilizer material. For agricultural planting implements, a fertilizer applicator/distribution system, such as the system disclosed in U.S. Patent Application No. 63/261,973, filed Oct. 1, 2021, which is hereby incorporated in its entirety, can be included with the row units of the planter. This system provides the application of the fertilizer contemporaneously, or near-contemporaneously, with the planting of the seed. However, it should be appreciated that the system can be used to apply liquid fertilizer at other times, such as before or after the planting of the seed as well. The system can include one or more hoppers/tanks, either at the bulk hopper site, at the individual row units, or split out to cover regions or sections of row units, wherein the application sites will be fed an amount of the liquid fertilizer.

In order to provide better consistency of application as well as other advantages, a calibration system, such as shown and described herein, can be included to calibrate a liquid fertilizer application/distribution system, such as the system disclosed in U.S. Patent Application No. 63/261,973. The calibration system can be included with the row units of the planter at individual row units or split to cover regions or sections of row units. Still further, the calibration system could be positioned at the bulk hoppers containing the liquid fertilizer before it is fed to the individual row units.

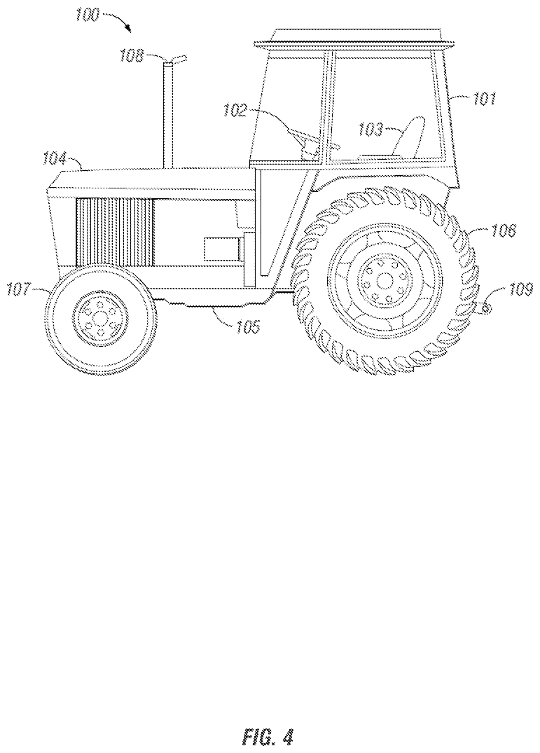

FIG. 4 discloses an exemplary agricultural vehicle 100 (e.g., a tractor) used for the purposes of towing machinery used in agriculture (e.g., agricultural implements). Accordingly, the vehicle may be referred to as a prime mover, tow vehicle, or the like. In some aspects, the agricultural vehicle 100 may be used to tow an agricultural implement such as the agricultural implement 10 depicted in FIGS. 1-3. The agricultural vehicle 100 may include a cab 101 with a steering wheel 102 and a seat 103 for an operator. The agricultural vehicle 100 may also include a vehicle frame 104 which houses an engine located near the front axle of the agricultural vehicle 100 and in front of the cab 101. The cab 101 and vehicle frame 104 may be supported, structurally, by the agricultural vehicle's chassis 105, which attaches to rear drivable wheels 106 and front steerable wheels 107, said front steerable wheels 107 operationally connected to the steering wheel 102. An exhaust pipe 108 allows carbon monoxide to exit the agricultural vehicle 100 during operation of the engine. A vehicle hitch 109 allows for connection between agricultural machinery, such as agricultural implements, and the agricultural vehicle 100.

In some aspects, the agricultural vehicle 100 shown in FIG. 4 could be used to tow the agricultural implement 10 shown in FIGS. 1-3. As mentioned, a liquid fertilizer distribution system and calibration system, as shown and described herein, used to calibrate the distribution system could be included on the agricultural implement. However, it should also be appreciated that aspects of liquid fertilizer systems, including a calibration system as included herein, could be located on the agricultural vehicle 100. For example, it is known that vehicles, such as tractors, can include tanks that contain liquid fertilizer. This can be on fenders or other portions of the vehicle. The tanks could house the liquid fertilizer that is then distributed to an end use location, such as a dispenser on an implement of even directly connected to the tractor. The calibration system, as will be understood, could be used with such tanks to indicate the level of material in the tanks, as well as to provide the other advantages as disclosed herein. Thus, it is envisioned that generally any tank on any vehicle, implement, or otherwise could utilize the calibration system.

It is also envisioned that the agricultural vehicle 100 could be an autonomous or unmanned vehicle, such as that disclosed in U.S. Pat. No. 10,104,824.

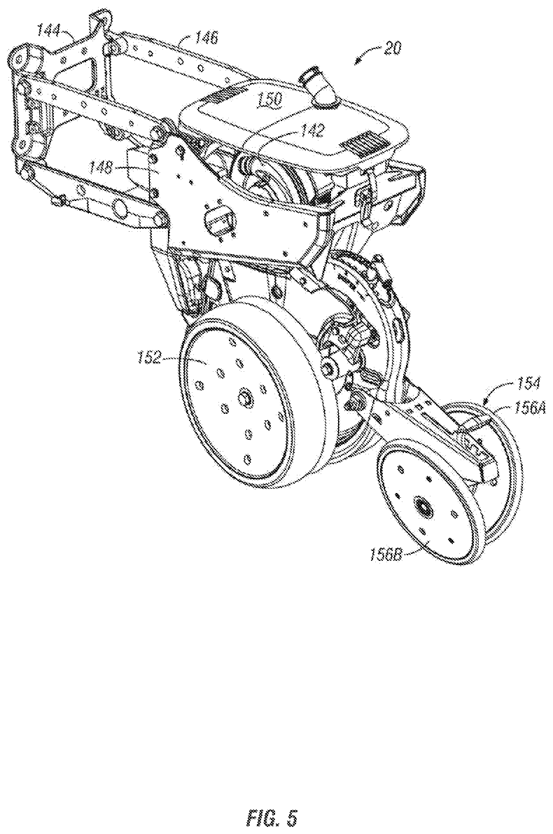

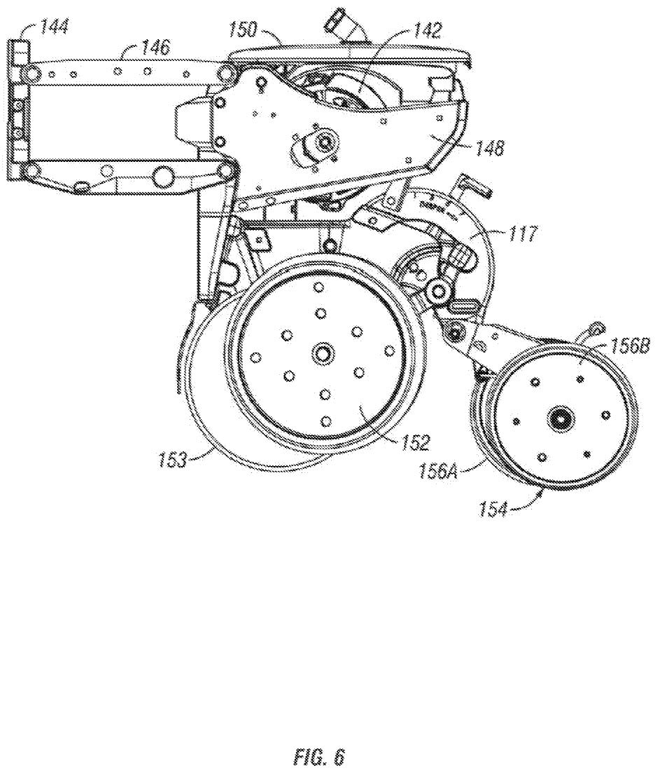

FIGS. 5 and 6 disclose an exemplary row unit of the plurality of row units 20, included as part of the implement 10, extending from the wings 17, 18 and the toolbar 16. A planter row unit 20 with an air seed meter 142 positioned therewith is shown in FIGS. 5 and 6. For example, the seed meter 142 may utilize a negative or positive air pressure to retain and transport seed about one or more seed discs within the seed meter housing. The row unit 20 and air seed meter 142 may be of the kind shown and described in U.S. Pat. No. 9,282,691, which is hereby incorporated in its entirety. However, it should be appreciated that aspects of embodiments of the present disclosure contemplate other types of seed meters, including mechanical, brush, finger, or the like, which may be used with the invention. In addition, the seed meter may be a multi-hybrid seed meter that is capable of dispensing one of a plurality of types, varieties, hybrids, etc. of seed at a row unit, such as by the use of multiple seed discs within the seed meter housing. In addition, when the implement 10 is not a planting implement, the row units may take other forms, such as those for engaging with the ground associated with the particular type of implement (e.g., tillage equipment or the like).

The row unit 20 includes a U-bolt mount (not shown) for mounting the row unit 20 to the planter frame or tool bar 16 (on central frame and wings 17, 18), as it is sometimes called, which may be a steel tube of 5 by 7 inches (although other sizes are used). However, other mounting structures could be used in place of the U-bolt. The mount includes a face plate 144, which is used to mount left and right parallel linkages 146. Each linkage may be a four bar linkage, as is shown in the figures. The double linkage is sometimes described as having upper parallel links and lower parallel links, and the rear ends of the parallel links are pivotally mounted to the frame 148 of the row unit 20. The frame 148 includes a support for the air seed meter 142 and seed hopper 150, as well as a structure including a shank 117 for mounting a pair of ground-engaging gauge wheels 152. The frame 148 is also mounted to a closing unit 154, which includes a pair of inclined closing wheels 156A, 156B. The row unit 20 also includes a pair of opener discs 153. While the row unit 20 shown in FIGS. 5 and 6 is configured to be used with a bulk fill seed system, it is to be appreciated that the row unit 20 may have one or more seed hoppers 150 at each of the row units 20. Exemplary versions of row units with individual hoppers are shown and described in U.S. Pat. No. 9,420,739, which is hereby incorporated in its entirety.

The implement 10 and row units 20 shown and described in FIGS. 5 and 6 include an air seed meter 142 for singulating and transporting seed or other particulate material from the seed delivery source to the created furrow in the field prior to the closing wheels 156A, 156B closing said furrow.

Still further, it should be appreciated that a fertilizer distribution system and a calibration system as disclosed herein could be used with other types of agricultural implements, including, but not limited to, sprayers, tillage equipment, plows, discs, and the like. The system can be configured to work with generally any type of implement to be able to better apply material, such as liquid fertilizer, to a field as the implement moves therethrough.

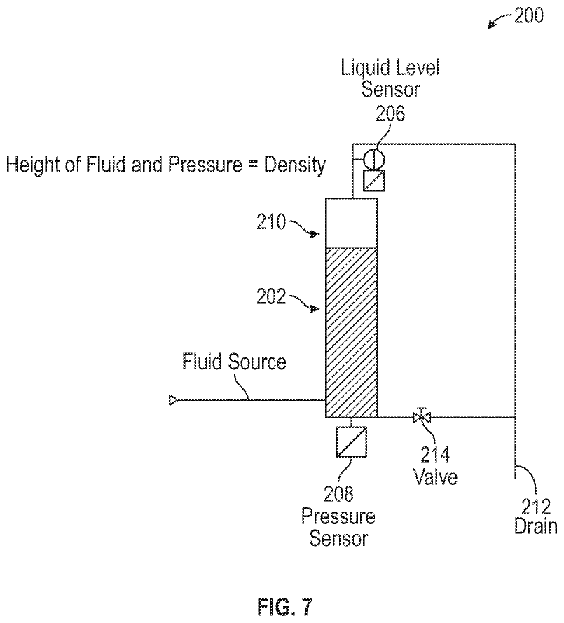

FIG. 7 shows a schematic drawing of an exemplary embodiment of a calibration system 200, according to some aspects and/or embodiments of the present disclosure, used to calibrate fertilizer distribution and/or a fertilizer distribution system. The embodiment depicted in FIG. 7 includes a tank/hopper 210 used to store liquid fertilizer 202. Although this embodiment only shows a single tank/hopper, the number of tanks used in the system could number from one to N, where N can be any number greater than one. Additionally, the tank or tanks could be in the form of bulk tanks for all of the row units, nozzles, dispensing points of an implement, tanks for a collection or region of row units, or could be provided on-row for each of the row units. The depiction shown in FIG. 7 includes a liquid level sensor 206 used to measure the liquid level of the liquid fertilizer 202. However, other methods of measuring the liquid level of the liquid fertilizer 202 could be used. Also, although the embodiment depicted in FIG. 7 only shows one liquid level sensor, multiple liquid level sensors could be used for each tank. When measuring the level of the liquid fertilizer 202, the liquid level sensor 206 may measure the liquid fertilizer's 202 height in a closed, or partially closed, space. The liquid level sensor 206 can be used to measure the height of the liquid fertilizer 202 currently being stored in the tank 210. This measured height can then be used as part of a calculation to determine the density of the liquid fertilizer 202. By measuring the height of the liquid fertilizer 202, its volume can be determined, which is part of the calculation of density (e.g., density=mass/volume). The embodiment of FIG. 7 also includes a pressure sensor 208 to measure the pressure of the liquid fertilizer 202 currently being stored in the tank 210. However, other methods of measuring the pressure of the liquid fertilizer 202 could be used. Also, although the embodiment depicted in FIG. 7 only shows one pressure sensor, multiple pressure sensors could be used for each tank. By measuring the pressure of the liquid fertilizer 202 currently being stored in the tank 210, the pressure sensor 208 can also measure the weight and/or mass of the liquid fertilizer. By measuring the pressure of the liquid fertilizer 202, its mass can be determined, which is part of the calculation for density. Therefore, density of the liquid fertilizer 202 can be determined as a function of its height and pressure.

The liquid level sensor 206 may take many forms, including, but not limited to, an ultrasonic sensor, a rod with a float, an optical sensor to detect when a level has been reached in a container, a proximity sensor, or generally any other sensor that can detect a level or distance of liquid fertilizer in a container. For example, the distance determination can be used with the known size (e.g., area) of the container to determine a volume of the liquid fertilizer.

Still further, it should be appreciated that tank 210 or other holding device could have a fixed or known volume, such that the level sensor is not required. The known volume tank 210 could be filled, and the volume and sensed pressure could then be used to calculate the density of the liquid fertilizer stored therein. This would remove the need to have a separate level sensor. While the container would have a known volume, there could still be a sensor included that could determine when the container reaches the known volume level, which could be the top of the container or some level less than the top. Such a sensor could be an optical sensor, level sensor, distance sensor, or other sensor that is able to detect when the liquid fertilizer reaches a fill line that corresponds to the known volume of the container, and then the volume and the measured mass by the pressure sensor could be used to determine the density of the liquid fertilizer therein.

The calibration system 200 may continuously monitor the height and pressure of the liquid fertilizer currently being stored in the tank 210. Therefore, the calibration system can recognize a change in density and alert the fertilizer distribution system so that the change in density can be accounted for when distributing fertilizer. Differing densities of liquid fertilizer can cause inconsistent and/or choppy distribution of fertilizer. Differing densities of liquid fertilizer can also cause under or over-application of fertilizer. For example, if a first liquid fertilizer having a first density is used by a fertilizer distribution system and then a second fertilizer having a second density is used by the fertilizer distribution system, the differing densities will have an effect on the distribution of the fertilizer in an agricultural field. Thus, by monitoring the density via the measured height and pressure of the liquid fertilizer, a fertilizer distribution system can be calibrated via the calibration system 200 to account for changes in density to provide better consistency in distribution. Also, weather conditions, such as ambient air pressure and/or ambient temperatures, may cause fluctuations in the density of the liquid fertilizer. Thus, by the calibration system 200 continuously monitoring the density of the liquid fertilizer 202, a distribution system can account for any changes in density due to weather conditions. In addition, the continuous checking and updating of the density will notice changes in densities within the same batch of liquid fertilizer, such as when it changes due to the composition of the fertilizer. However, as different batches of fertilizer may not be exactly the same, the changing density will allow the system to account for the difference in fertilizers.

In order to accurately measure the fullness of a tank, also referred to as tank level, it is useful not only to measure and be aware of the level of liquid fertilizer in said tank but also the density of the liquid fertilizer. For example, simply measuring the weight/mass or the level of the fertilizer may not give all of the correct information needed for a fertilizer system. A tank's tank level corresponds to the liquid level of liquid fertilizer contained in the tank as well as the density of the liquid fertilizer. Therefore, by measuring the level of liquid fertilizer as well as the liquid fertilizer's density, the system 200 is able to provide an accurate measurement of tank level.

FIG. 7 also shows a drain 212, through which the liquid fertilizer 202 drains from the tank 210 and is applied to an agricultural field. FIG. 7 shows the exemplary drain 212 operatively positioned near the bottom of the tank 210, but other configurations of the positioning of the drain 212 relative to the tank 210 are possible. The system 200 may include one or more conduits through which liquid fertilizer 202 may be transported throughout the system.

FIG. 7 also shows an exemplary valve 214 positioned between the tank 210 and the drain 212. Liquid fertilizer first travels from the tank 210 through the valve 214 before being dispensed onto an agricultural field via the drain 212. Thus, the calibration system 200 can selectively open and/or close the valve based on the density of the liquid fertilizer 202 in order to apply the proper amount of fertilizer to an agricultural field.

As disclosed, by including a liquid level sensor 206 and pressure sensor 208, the calibration system 200 can measure the tank level of a particular tank, meaning that by measuring the amount of liquid fertilizer currently being stored in the tank, as well as its density, the system 200 can measure how full a particular tank is. By measuring the tank level, the calibration system 200 may automatically fill, or autofill, the tank 210 with additional liquid fertilizer. In one embodiment, the system 200 may use one or more valves to autofill the tank 210. If and when the tank level, which is a measurement corresponding to the level of liquid fertilizer and its density, falls below a configurable threshold, the system 200 can autofill the tank 210 with additional fertilizer in order to reach a different configurable threshold. In addition, between uses (e.g., between fields), the tanks can be refilled. Using autofill will efficiently fill the tank(s) with the desired amount of fertilizer. Using the density calculations will calibrate the system to make sure that the correct amount of fertilizer is added. By measuring and being cognizant of the density of the liquid fertilizer, the calibration system allows for a more accurate measurement of the tank level. Further, a user may offer input commanding the system to either engage in autofilling or to not engage in autofilling. A user may also offer input to configure the tank level threshold at which the autofill feature of the system will begin filling a tank and the tank level threshold at which the autofill feature of the system will cease to fill the tank.

Additional benefits of knowing the density of the liquid fertilizer should be apparent to those skilled in the art, but include and are not to be limited to, a better or improved flow and/or dispensing rate of the liquid fertilizer, such as by choice of orifice. This could also be controlled via valve, such as a ball valve. Liquid fertilizer generally includes the use of tables that provide information to a user for the application rate of the liquid fertilizer, such as based upon the speed of the application vehicle. Current tables only provide approximations and are not generally accurate. Knowing the density of each batch of liquid fertilizer will provide more accurate suggestions for the settings of the system, such as the flow rate, orifice selection, and/or other determinations required.

Yet additional advantages include the ability to check formulations from mix to mix, which will provide better assurance that the particular mix of liquid fertilizer is within a desired or known density based upon the inputs. The known density would allow for the fluid level in a tank to be determined without the need for a scale, which is not always accurate.

Still further, the known density can allow changes to be made during application, such as when temperature may affect the density/viscosity of the liquid fertilizer being applied.

While FIG. 7 shows the determination of the density of the liquid fertilizer to be done in a separate container, it should be appreciated that this can be done in the larger storage tanks housing the liquid fertilizer. As mentioned, if the volume of the container is known, adding a pressure sensor to determine the mass of the liquid fertilizer in the tank can provide the density thereof, which will provide the direct density reading in the tank, without the need to fill a separate container for the determination. However, the level of the liquid fertilizer could also be measured in the tank, and then the volume determined using other calculations, such as when the exact volume is not readily known.

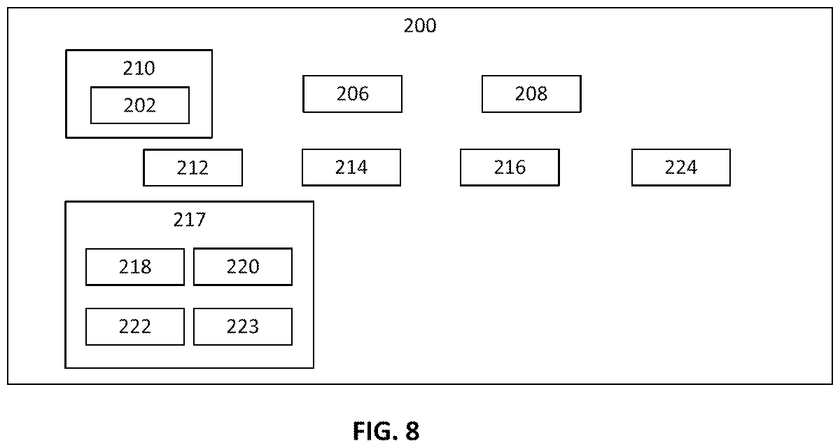

FIG. 8 shows a block diagram of an exemplary embodiment of the calibration system 200 including the components of liquid fertilizer 202 stored in a tank 210, a liquid level sensor 206, a pressure sensor 208, a drain 212, a valve 214 positioned between the tank 210 and the drain 212 that is capable of opening and closing depending on whether liquid fertilizer is or is not desired to be applied to an agricultural field, a tilt sensor 216, an implement control system 217 that includes an intelligent planter router or intelligent implement router (IPR/IIR) 218, an intelligent planter node or intelligent implement node (IPN/IIN) 220, an intelligent planter positioning or intelligent implement positioning (IPP/IIP) 222, and a display 223. The embodiment of the system 200 depicted in FIG. 8 also includes an accelerometer 224. The tilt sensor 216 is used to measure any tilt experienced by the calibration system, the fertilizer distribution system that the calibration system is being used to calibrate, or the agricultural vehicle/implement upon which the calibration system and/or fertilizer distribution system is positioned. The various systems and/or agricultural vehicle/implement may experience tilt when traversing a hill or any kind of rough, uneven, or otherwise abnormal terrain. Thus, by including a tilt sensor to measure tilt, if and when the calibration system, fertilizer distribution system, and/or agricultural vehicle/implement experience tilt, the calibration system can account for said tilt when measuring the height and pressure of the liquid fertilizer in a particular tank and still render an accurate measurement of the height and pressure of the liquid fertilizer as well as an accurate measurement of the density and tank level. Thus, when calculating the density of liquid fertilizer and the tank level of a tank, the system 200 accounts for any tilt being experienced by the apparatus involved. Therefore, by accounting for any tilt, the calibration system is still able to accurately calibrate a fertilizer distribution system to apply the desired amount of fertilizer material to an agricultural field. Additionally, by accounting for any tilt, the calibration system is still able to accurately provide the autofill capabilities even in circumstances where any portion of the apparatus involved is experiencing tilt. By accounting for any tilt, the tilt sensor allows the tank level to be accurately measured even when any part of the apparatus involved is experiencing any tilt. Although the embodiment depicted in FIG. 8 only shows one tilt sensor, multiple tilt sensors could be used.

FIG. 8 also shows an accelerometer 224 as part of the exemplary embodiment of the system 200. The accelerometer 224 is used to measure the speed and/or acceleration of the calibration system 200, a fertilizer distribution system being calibrated by the calibration system 200, and/or an agricultural vehicle/implement upon which the calibration system 200 is positioned. The accelerometer 224 can measure speed and acceleration in a variety of directions (e.g., an x-direction, a y-direction, etc.). By measuring the speed and/or acceleration, a more consistent application of liquid fertilizer can be applied to an agricultural field since the amount of fertilizer applied may depend on the speed and/or acceleration of the apparatus involved.

FIG. 8 also shows an implement control system 217 that includes an IPR 218, IPN 220, IPP 222, and a display 223 as part of the exemplary embodiment of the system 200. The implement control system, including an IPR, IPN, IPP, and display, may be that which is disclosed in U.S. Pat. No. 10,952,365 which is hereby incorporated in its entirety. According to some aspects, the calibration system 200 disclosed herein may utilize the implement control system 217, which may include zero or more IPRs 218, zero or more IPNs 220, zero or more IPPs 222, and zero or more displays 223. Pertinent to the disclosed calibration system, the implement control system 217 of U.S. Pat. No. 10,952,365 may be adapted to detect, sense, monitor, and/or perform functionality related to fertilizer distribution and/or the calibration of a fertilizer distribution system. For example, the features and capabilities of the calibration system 200 may be performed and carried out by the implement control system 217. As described herein, this includes the ability to accurately measure and monitor the density of the liquid fertilizer in the system, the ability to provide consistent application of fertilizer when tilting occurs, the ability to accurately measure a tank level based in part on the density of the liquid fertilizer contained in said tank, the autofill capabilities, and the ability to selectively pull fertilizer material from a particular tank or tanks. One or more IPPs may act as sensors to collect data related to these functions, and the one or more IPNs and IPRs may be used to control and perform certain functions. Further, control and performance of certain functions may depend on user input offered via the display 223. The display 223 may be configured to display information and/or data to a user regarding the sensing, monitoring, measuring, and/or functionality of the system. The display 223 may also be configured for a user to offer input.

For example, one or more IPPs can be used in conjunction with the liquid level sensor 206 and the pressure sensor 208 when sensing and measuring the height of the liquid as well as its pressure in order to calculate the liquid's density as well as the tank level of the tank in which the liquid is contained. One or more IPPs can also work in conjunction with the tilt sensor 216 to sense and determine when any part of the apparatus involved is experiencing tilting and account for the tilt when measuring the height, pressure, and density of the liquid fertilizer and the tank level of the tank. One or more IPPs can work in conjunction with the system 200 to accurately sense and measure tank level when performing the autofill feature. Also, one or more IPPs can work in conjunction with the system 200 to accurately sense and measure tank level and tilt when selectively pulling fertilizer material from a particular tank or tanks in order to avoid and/or mitigate spillage.

The display 223 may be a digital interface, a command-line interface, a graphical user interface (“GUI”), oral interface, virtual reality interface, or any other way a user can interact with a machine (user-machine interface). For example, the display can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc.

The display 223 can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc.

Additionally, the calibration system disclosed herein may use Ethernet connections, Ethernet signals, Ethernet data transmission, and/or other types of connections, signals, and data transmission such as CAN bus or ISOBUS.

Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group/collection of IEEE standards produced by the working group defining the physical layer and data link layer's media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

ISO 11783, known as Tractors and machinery for agriculture and forestry—Serial control and communications data network (commonly referred to as “ISO Bus” or “ISOBUS”) is a communication protocol for the agriculture industry based on the SAE J1939 protocol (which includes CAN bus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

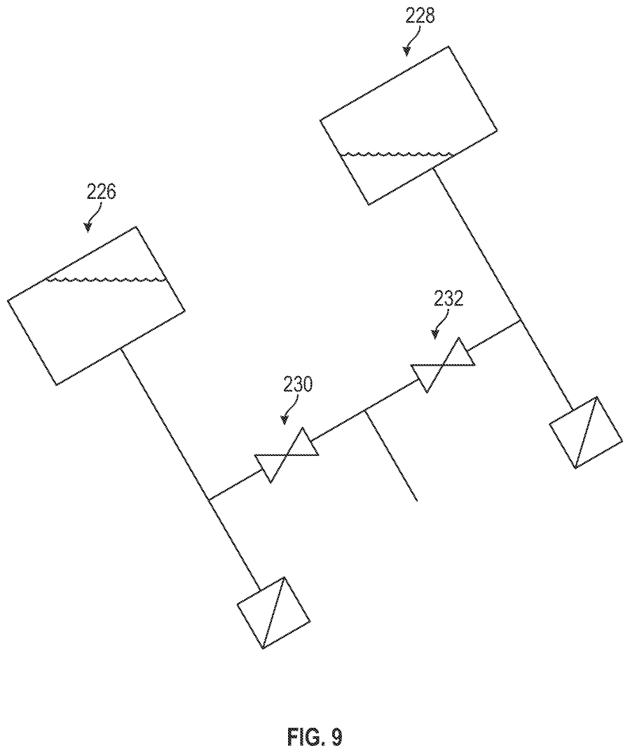

FIG. 9 shows another exemplary embodiment of the calibration system 200 that includes a first and second tank 226/228 and a first and second valve 230/232. The system 200 can selectively pull/draw liquid fertilizer from a particular tank, via the valves, when applying liquid fertilizer to an agricultural field. The system 200 can also selectively stop pulling/drawing liquid fertilizer from a particular tank, via the valves, when applying liquid fertilizer to an agricultural field. For example, the exemplary embodiment of FIG. 9 depicts two tanks, a first tank 226 and a second tank 228. FIG. 9 also depicts two valves, a first valve 230 associated with the first tank 226, and a second valve 232 associated with the second tank 228. FIG. 9 depicts the system 200 traversing a hill so that the system 200 is tilted. In the example depicted in FIG. 9, the first tank 226 is fuller than the second tank 228. The determination of fullness of the tanks may be made by measuring respective tank levels, which is a measurement corresponding to the level of liquid fertilizer in the tank as well as the liquid fertilizer's density. Therefore, to avoid and/or mitigate any fertilizer spillage, the system can manipulate the respective valves 230/232 to pull/draw fertilizer from the first tank 226, in this example the first tank 226 is the fuller tank and stop pulling/drawing from the second tank 228. By pulling fertilizer from the fuller tank, the system is able to mitigate potential spillage that may result when the system 200 traverses a hill. Manipulation of the valves may involve opening or closing the valves, or via other means. The system 200 can selectively pull from a particular tank or choose to not pull from a particular tank for many reasons. Some possible reasons may be based on the tank level of each tank, the nature of the terrain in which the system 200 is traversing, and/or other environmental factors. Further, a user may offer input commanding the system to automatically selectively pull fertilizer from a particular tank or tanks. A user may also offer input commanding the system not to automatically selectively pull fertilizer from a particular tank or tanks.

In addition, either on a side hill or otherwise, aspects of the embodiments provided can be used to otherwise control the material levels in the containers, such as containers 226 and 228. For example, when returning unused liquid fertilizer from the conduits of the system, valves could be included to direct the unused/purged liquid fertilizer to a container having a lower level of liquid fertilizer (e.g., container 228 in FIG. 9). This would aid in more evenly distributing the liquid fertilizer between bulk hoppers.

In addition, it should be appreciated that any of the systems as provided herein could include a selective draw setting that would automatically move some liquid fertilizer from one tank/hopper to another, such as from a higher filled tank to a lower level tank. Such a system could include a sump or pump that would be connected between the containers, and that would draw liquid fertilizer from one tank (e.g., tank 226 in FIG. 9) to another tank (e.g., tank 228 in FIG. 9). This would more evenly distribute the liquid fertilizer in the system for more even usage and to better allocate the liquid fertilizer for distribution.

Therefore, as understood from the present disclosure, the calibration system provided includes calculating the density of liquid fertilizer by measuring its height and its pressure. By continuously being cognizant of the density of the liquid fertilizer, more consistent application of the fertilizer to an agricultural field can be achieved.

Further, the calibration system provided includes the ability to accurately measure the height and pressure of fertilizer in the tank, and thus accurately determine density of the fertilizer, even in situations when a portion of the apparatus involved is experiencing tilt caused by, for example, a hill or other rough terrain. By being able to accurately measure density even when the apparatus is tilted, the system is still able to provide proper calibration resulting in more consistent and/or desirable application of fertilizer on an agricultural field.

Further, the calibration system provided includes the ability to accurately measure the fullness of a tank, also referred to as the tank's tank level. The system can factor in the height, pressure, and density of liquid fertilizer contained in a tank to accurately measure tank level. The system can also account for any tilt of the apparatus involved when measuring tank level to improve accuracy.

Further still, the calibration system provided allows for tanks to automatically fill, also known as autofill, based on a measured tank level. For example, because the system continuously measures the level of fertilizer material currently being stored in the tank or tanks as well as its density, the system can automatically fill the tank or tanks when the fertilizer level is low.

Even further, the calibration system provided includes the ability to selectively draw fertilizer from a particular tank or tanks when applying fertilizer to an agricultural field. For example, in a situation in which a first tank is fuller than a second tank, the system can selectively choose to draw fertilizer from the first tank and not from the second tank when traversing a hill in order to mitigate spilling fertilizer material.

From the foregoing, it can be seen that the invention accomplishes at least all of the stated objectives.

1. A system for calibrating liquid fertilizer distribution for an agricultural implement comprising:
a tank wherein liquid fertilizer is stored;
a liquid level sensor to measure the level of the liquid fertilizer stored in the tank; and
a pressure sensor used to measure the pressure of the liquid fertilizer stored in the tank.

2. The system of claim 1, further comprising a drain and a valve, wherein the liquid fertilizer may be released out of the tank through the drain and be applied to an agricultural field, and the valve is positioned between the tank and the drain wherein the valve may be open or closed, thereby dictating whether the liquid fertilizer is released from the tank.

3. The system of claim 1, further comprising a tilt sensor to measure the tilt of the agricultural implement and/or the system of claim 1, and account for any tilt when the level and/or pressure of the liquid fertilizer is being measured.

4. The system of claim 3, wherein the tilt sensor is able to recognize when the agricultural implement is traversing a hill or otherwise rough terrain by measuring the tilt of the agricultural implement and/or the system of claim 3.

5. The system of claim 1, further comprising a plurality of tanks with one or more valves positioned between the plurality of tanks, in which the system can use the one or more valves to selectively draw liquid fertilizer from a particular tank or tanks to mitigate spillage.

6. The system of claim 1, further comprising an accelerometer to measure the speed and acceleration of the agricultural implement.

7. The system of claim 1, wherein, based on a measured tank level, the system can autofill the tank with additional liquid fertilizer.

8. The system of claim 1, further comprising an implement control system comprising zero or more IPRs, zero or more IPNs, zero or more IPPs, and zero or more displays, wherein the implement control system can sense, measure, monitor, and/or control aspects of the system of claim 1.

9. A system for calibrating liquid fertilizer distribution for an agricultural implement comprising:
one or more tanks for storing and distributing liquid fertilizer;
one or more liquid level sensors to measure the level of the liquid fertilizer stored in the one or more tanks; and
one or more pressure sensors used to measure the pressure of the liquid fertilizer stored in the one or more tanks.

10. A method for calibrating liquid fertilizer distribution for an agricultural implement comprising:
determining the volume of liquid fertilizer stored on or near the agricultural implement;
measuring the pressure of the liquid fertilizer stored on or near the agricultural implement;
calculating the density of the liquid fertilizer based on the volume and pressure of the liquid fertilizer; and
calibrating a liquid fertilizer system of the agricultural implement based upon the calculated density of the liquid fertilizer.

11. The method of claim 10, further comprising opening or closing a valve to drain the liquid fertilizer from the agricultural component and apply the liquid fertilizer to an agricultural field.

12. The method of claim 10, further comprising measuring the tilt of the agricultural implement and accounting for the tilt of the agricultural implement when measuring the level and/or pressure of the liquid fertilizer.

13. The method of claim 12, wherein the step of measuring the tilt of the agricultural implement includes recognizing when the agricultural implement is traversing a hill or otherwise rough terrain.

14. The method of claim 10, further comprising storing the liquid fertilizer in one or more tanks.

15. The method of claim 14, further comprising selectively drawing liquid fertilizer from a particular tank or tanks, via one or more valves, to mitigate spillage.

16. The method of claim 10, further comprising measuring speed and/or acceleration of the agricultural implement.

17. The method of claim 14, further comprising:
measuring a tank level of the one or more tanks, and
automatically filling the agricultural implement with additional liquid fertilizer, based on the measured tank level.

18. The method of claim 10, further comprising including an implement control system comprising zero or more IPRs, zero or more IPNs, zero or more IPPs, zero or more displays, wherein the implement control system can sense, measure, monitor, and/or perform aspects of the method of claim 10.

19. The method of claim 10, wherein the volume is determined by measuring a level of the liquid fertilizer in the container.

20. The method of claim 10, wherein the volume is determined by identifying a known volume of the liquid fertilizer in the container based upon a level of the liquid fertilizer in the container.
